(19) United States
(12) Patent Application Publication
(10) Pub. No.: US 2003/0057904 A1
(43) Pub. Date: Mar. 27, 2003

(54) Process and device for feedback-controlling rotary machines

(76) Inventor: Ing. Manfred Sacher, Vienna (AT)

Correspondence Address: HOFFMANN & BARON, LLP, 6900 JERICHO TURNPIKE, SYOSSET, NY, 11791, US

(21) Appl. No.: 10/223,588

(22) Filed: Aug. 19, 2002

(30) Foreign Application Priority Data
Aug. 22, 2001 (EP) 01890243.7

(51) Int. Cl. H02P 5/00

(52) U.S. Cl. 318/268

(57) ABSTRACT

The invention relates to a process and device for feedback-controlling the speed of an electric motor (10) driving a rotary machine (6), in particular a pump or fan, according to the capacity requirement at the rotary machine, which is variable with time on the consumer side (4, 8) thereof, using a feedback controller (16) the output of which determines the speed of the electric motor (10). The process according to the invention is characterized in that the electrical power (P) actually taken up by the electric motor (10) is measured and in that a signal representing the electrical power measured is produced and supplied as input to the feedback controller (16), where it is converted into the desired output according to a predetermined or right then calculated characteristic curve (Pᵢₙₛₜₐₗₗ(Q)).

The present invention relates to a process and device for feedback-controlling the speed of an electric motor driving a rotary machine, in particular a pump or fan, according to the capacity requirement at the rotary machine, which is variable with time on the consumer side thereof, using a feedback controller the output of which determines the speed of the electric motor.

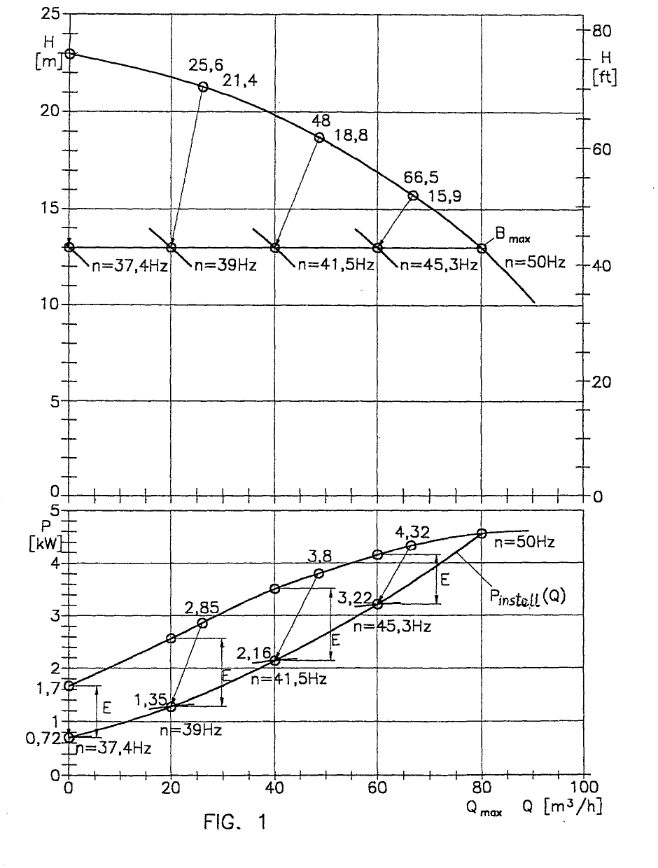

Rotary machines, like pumps, fans or ventilators, blowers, compressors, etc., driven by an electric motor are frequently used in installations wherein the capacity of the rotary machine required by the installation changes with time. This is for instance the case with fans in air conditioning equipment or with pumps in heating installations. Here, the maximum pumping head is only required when all consumers are connected. In practical operation, however, the consumers, for instance individual heaters or certain portions of the air conditioning equipment, are operated at reduced level only or completely disconnected at certain times, which results in quite different operating conditions with different pumping head requirements variable with time. However, the maximum capacity of the rotary machine(s) in such an installation always has to be dimensioned so that all consumers within the installation can be supplied sufficiently even if all of them are connected at maximum consumption at the same time. If the rotary machine is operated at full capacity all the time, i.e. also in case of reduced pumping head requirements, this—unnecessarily—results in the continuous consumption of the maximum amount of energy, as it raises the pumping head of the machine beyond the level required. This behavior is illustrated with reference to a rotary fluid pump in the upper part of the graph of FIG. 1, showing a family of characteristic pump curves of the rotary pump, i.e. the pumping head H as a function of the capacity Q at a certain rotational speed n. This graph only shows the characteristic curve of the pump for its rotational speed of n=50 Hz in its entirety, other characteristic curves of the pump for n=45.3 Hz, n=41.5 Hz, n=39 Hz, and n=37.4 Hz only being shown as curve portions.

For dimensioning the capacity required of such a rotary pump in an installation, a point of operation Bmax is set, which is the point of intersection of a required maximum capacity Qmax (in this example 80 m³/h), when all consumers are fully connected, and the pumping head H required for smooth operation of the installation (in this example 13m) at this capacity Qmax. The characteristic pump curve intersecting this point of operation Bmax (in this example the curve for n=50 Hz) gives the maximum rotational speed of the pump necessary for maintaining the required pumping head at 100% consumption (=Qmax). But if the actual consumption within the installation decreases and the pump continues to be operated at the same rotational speed n=50 Hz, the pumping head H rises, i.e. the actual point of operation at a certain moment shifts to the left along the characteristic pump curve, as illustrated by way of three arbitrarily chosen points, representing consumptions of 66.5 m³/h, 48 m³/h, and 25.6 m³/h, which bring about respective pumping heads of 15.9 m, 18.8 m, and 21.4 m, values well beyond the required 13 m. Thus it can be seen that operating an installation in this way is highly uneconomical. In addition there may be disturbing noise resulting from flow if the pumping head is considerably higher than that actually needed in the installation.

In order to optimize energy consumption and noise behavior, the respective pumping head of the rotary machine is thus advantageously feedback-controlled according to the capacity actually required at a certain time. As the capacity of a rotary machine depends on its rotational speed, a commonly used method is to feedback-control the capacity by feedback-controlling the rotational speed of the rotary machine and of the electric motor driving it, respectively. Again referring to the pumping head/capacity graph of FIG. 1, it shows how the rotational speed of the pump has to change in order to maintain a constant pumping head H of 13 m at varying consumptions. In order to realize such feedback control it is known to install a pressure sensor at the pump outlet, the output signal of which is proportional to the pumping head. This output signal constitutes the actual value fed to a control circuit (for instance a PID controller). The nominal value of the control circuit is provided by a signal representative of the desired pumping head. If the feedback controller determines that the actual pumping head at a certain moment is higher than the nominal value, it transmits an output signal to a speed regulator (e.g. a frequency converter) of the pump motor, prompting it to reduce the speed of the motor. Reducing the speed of the motor and thus that of the pump results in a reduction of the pumping head, but at the same time also in a reduction of the capacity. For when the rotational speed is changed, a point of operation of a certain characteristic curve of the pump “travels” along a parabola to a new position on the characteristic pump curve for the new rotational speed. The graph shows this by way of the points of operation on the characteristic curve of the pump for n=50 Hz for pumping heads of H=15.9 m, 18.8 m, and 21.4 m. If the rotational speed of the pump is reduced until the desired pumping head of H=13 m has been reached, the new points of operation are on the characteristic curves of the pump for n=45.3 Hz, n=41.5 Hz, and n=39 Hz, respectively. It is to be noted that the graph only shows an approximate representation of the change of the point of operation along parabolas by way of straight segments of a line. By using the above feedback controller it is possible to adjust the rotational speed for any actual capacity at a certain moment in such a way that the desired pumping head is achieved.

Feedback control of the pump to a constant pumping head brings about energy savings as compared to operating the pump at constant rotational speed, which is shown in the power uptake/capacity graph in the lower part of FIG. 1. The respective energy saving is represented by arrow heads E for the selected points of operation. It can be seen that energy savings of up to 50% as compared to operation of the pump without feedback control can be achieved.

While the above feedback control of a rotary pump at a constant pumping head constitutes a useful approach for reducing energy consumption, it is not yet an optimum solution for closed systems with a fluid circulating therein. These closed systems are generally characterized in that the characteristic curve of the installation is not linear, but that with increasing capacities their pumping heads rise superproportionally, which is substantially due to increasing resistance (friction, whirling, etc.) inside the pipelines. In a central heating system, for instance, with only a few heaters open, the pumping head of the heating pump may be low, and still enough heating medium may be circulated through the open heaters; but if all heaters are opened, the pumping head of the pump must be raised superproportionally in order to ensure that, in spite of the inevitable pressure losses in the supply and return pipes, enough heating medium flows even through the heater at the greatest distance from the heating pump.

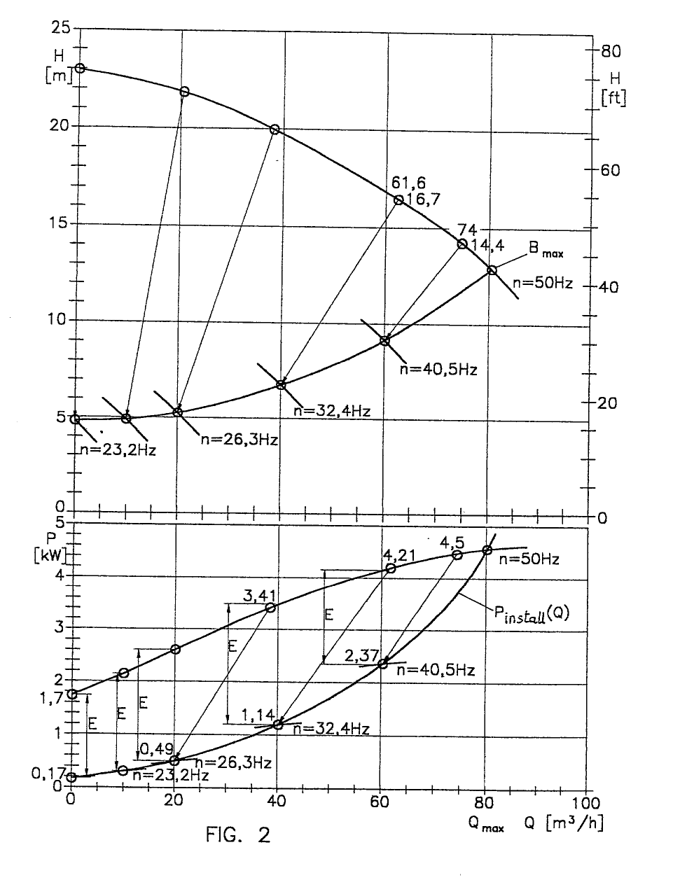

The behavior of such an installation is shown in the graphs of FIG. 2, in which the installation curve, i.e. the required pumping head as a function of the capacity, rises about quadratically with the capacity. The maximum consumption Qmax was defined to be 80 m³/h (see point of operation Bmax); the characteristic curve of the pump passing through Bmax gives the maximum required rotational speed of the pump, which in this case is n=50 Hz. As in the graph of FIG. 1, FIG. 2 also shows a number of arbitrary points of operation on the characteristic curve of the pump for n=50 Hz and their displacement by speed reduction until the characteristic curve of the installation has been reached. Comparing the graphs of FIGS. 1 and 2, it can be seen that with the about quadratically rising course of the characteristic curve of the installation according to FIG. 2, significantly higher energy savings (see arrow heads E in the power uptake/capacity graph) are possible than with the horizontal characteristic curve of the installation shown in FIG. 1, i.e. the described constant pumping head for all capacities.

The above graphs clearly show that taking the actual characteristic curve of the installation into consideration is highly advantageous from the point of view of energy consumption. There are problems, however, when this is put into practice. For while only one pressure sensor at the outlet of the pump, sensing the actual value, is necessary for feedback-controlling a rotational speed of the pump at a constant pumping head, a pressure differential sensor is necessary if the characteristic curve of the installation is variable. This is a very expensive component, however, the cost of which accounts for about 70% of the total costs for the feedback control instrument. Therefore variable feedback control has so far often been left aside in spite of its undeniable technical advantages.

It is known to use flow meters instead of pressure differential sensors in order to feedback-control the pump capacity in direct dependence on the fluid flow, but from the financial point of view, this solution is frequently unacceptable as well.

In order to avoid the problem of the high costs for pressure differential sensors, document DE 44 23 736 A1 proposes a process for feedback-controlling the capacity of a rotary machine, as for instance a pump or a fan, driven by an electric motor, according to the capacity actually demanded on the consumer side at a certain moment. For this purpose the respective strength of the motor current of the electric motor is measured and used as input for a feedback-controller producing an output value for feedback-controlling the rotational speed in dependence on the current strength measured and according to a predetermined characteristic curve. In this way, for instance, it is possible to replace a pressure differential measurement for determining the required capacity by a current measurement. This known solution departs from the assumption that the motor current of an electric motor driving a rotary machine depends on the capacity actually demanded from it at a certain time and may thus directly be used for the feedback-control of the rotational speed. But this assumed relationship between motor current and required capacity of a rotary machine constitutes an oversimplification of the actual conditions, and thus in practice the effects of such feedback-control often are poor, namely in cases where the approximated relationship between motor current and capacity of the rotary machine deviates too much from the actual conditions.

Thus the present invention departs from a different approach which is not based on merely approximated conditions, but on true mathematical correlations. For it is possible to derive functions of the power uptake of an electric motor for driving a rotary machine in dependence on the actual capacity of the rotary machine at a certain moment. This results in families of curves of the power uptake of an electrical driving motor as a function of the capacity and speed of a rotary pump driven thereby, as for instance those shown in FIGS. 1 and 2 of the present invention. The flat course of these families of curves (see in particular the power curve for a rotary pump speed of n=50 Hz, shown in its entirety) also makes it clear why the current measurement proposed in document DE 44 23 736 A1 cannot work satisfactorily, as it departs from the assumption that the supply voltage of the electric motor is always kept constant. However, in practical operation, in particular in the industrial field, this is not the case; besides, the electric motor itself produces voltage variations in case of load alternations. In view of the flat course of the power curves and the multiplied distortion of the apparent point of operation on the power curve brought about by this, variations of the supply voltage of as little as 1 or 2% already ruin the effect of feedback control based on current measurements.

Therefore the present invention proposes a process for feedback-controlling the speed of an electric motor driving a rotary machine, in particular a pump or fan, according to the capacity requirement at the rotary machine, which is variable with time on the consumer side thereof, using a feedback controller the output of which determines the speed of the electric motor, the electrical power actually taken up by the electric motor being measured and a signal representing the electrical power measured being produced and supplied as input to the feedback controller, where it is converted into the desired output according to a predetermined or right then calculated characteristic power curve.

Conveniently a frequency converter is used for controlling the speed of the electric motor, the power measurement optionally being integrated in the electronic components of the frequency converter. As an alternative, the power may be measured in between the frequency converter and the electric motor.

The invention also relates to a device for carrying out the above process having an electric motor driving a rotary machine, control means for the speed of the electric motor, and a feedback controller the feedback-control output of which is connected to the control input of the control means. The device according to the invention is characterized in that a power measurement instrument is series connected ahead of the electric motor for measuring the electrical power taken up by the motor, the signal output of which instrument is connected to the input of the feedback controller.

In view of simple feedback control the control means advantageously is a frequency converter. A power measurement unit may be integrated in the electronic components of the frequency converter, thus giving a compact, reliable embodiment.

The feedback controller is advantageously realized using a digital feedback-control instrument so as to ensure universal applicability and easy modification of feedback-control parameters.

In order to dispense with additional calculation circuits for determining the actual point of operation of the rotary machine at a certain moment, the rotary machine should have characteristic power curves of strictly monotonic course. Radial pumps and fans have monotonically rising characteristic power curves, while axial pumps and axial fans have monotonically failing characteristic power curves. Both types of rotary machines may be used according to the invention.

For a more detailed explanation of the invention several embodiments thereof will now be described with reference to the attached drawings. In the drawings,

FIGS. 1 and 2 each show graphs of characteristic curves of a pump, i.e. the pumping head as a function of the capacity, and characteristic curves of the power uptake of the pump motor as a function of the pump capacity.

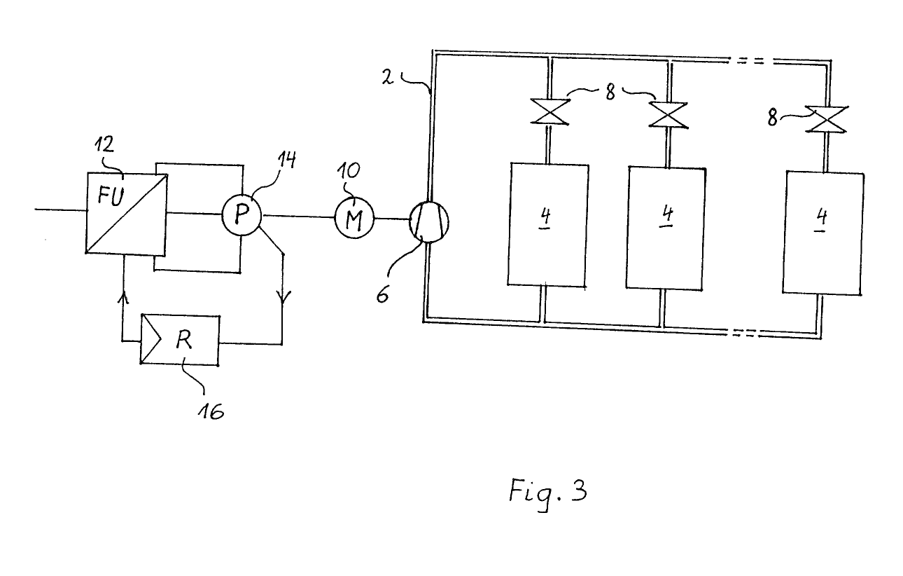

FIG. 3 is a schematic representation of a heating installation having a heating pump and an arrangement according to the invention for feedback-controlling the rotational speed of this heating pump.

A detailed discussion of the pumping head/capacity graphs of the pump shown in FIGS. 1 and 2 has already been given in the introduction, and with reference to the power uptake/capacity graphs of these figures, it has also been explained what energy savings E can be achieved by feedback-controlling the rotational speed of a rotary pump as compared to operating the pump at constant speed.

The feedback-controlling process according to the invention will now be discussed with reference to the power uptake/capacity graphs of FIGS. 1 and 2.

For every rotational speed of a rotary pump there is a characteristic curve of the uptake of electrical power by an electric motor driving the rotary pump as a function of the capacity of the rotary pump, so that the power uptake/capacity graph actually comprises families of curves of discrete power uptake curves for the various pump speeds. FIGS. 1 and 2 show the power uptake curves for a pump speed of n=50 Hz in their entirety; for other power uptake curves (n=37.4 Hz, n=39 Hz, n=41.5 Hz, n=45.3 Hz in FIG. 1; n=23.2 Hz, n=26.3 Hz, n=32.4 Hz, n=40.5 Hz in FIG. 2) only the portions of interest are shown. Furthermore, by analogy to the function of the pumping head in dependence on the capacity discussed above, it is also possible to define a function Pᵢₙₛₜₐₗₗ(Q) of the power uptake by the motor in dependence on the pump capacity which is determined by parameters of the entire installation. Furthermore, it is true that upon a modification of the rotational speed, points of operation situated on a certain characteristic power uptake curve “travel” to a new position on the characteristic power uptake curve for the new rotational speed, it being possible to calculate the course of their “travel” by a cubic equation, while it is, schematically shown as a straight distance in the drawing. As examples for points of operation on the characteristic power uptake curve for n=50 Hz, FIG. 1 includes those for P=4.32 kW, 3.8 kW and 2.85 kW, and FIG. 2 includes those for 4.5 kW, 4.21 kW and 3.41 kW.

The inventive process for feedback-controlling the speed of the electric motor driving the rotary pump now is as follows: the power uptake by the electric motor is measured continuously, and a signal representing the measured electrical power is fed to a feedback controller as its input signal. If this input signal changes due to a modification of the capacity, the feedback controller checks whether this new power uptake value is on the predetermined (or even just calculated) characteristic curve of the installation or deviates therefrom. In case of deviations, the feedback controller produces an output signal prompting the required readjustment of the rotational speed of the pump to a new value, so that the electric motor will take up a power corresponding to a point on the characteristic curve of the installation. Employing this feedback control makes it possible to adjust the rotational speed of the pump for every actual capacity at a certain moment in such a way that it results in the desired power uptake by the electrical driving motor. As a result it is thus possible to achieve the same feedback-control behavior as when using pressure or pressure differential sensors, but without having to employ these components.

FIG. 3 schematically shows an example for a practical embodiment of the invention. It is a heating installation for residential buildings having a rotary pump 6 and an arrangement according to the invention for feedback-controlling the rotational speed of this rotary pump. Liquid heating medium is pumped to heaters 4 and back to the pump via a conduit system 2, heaters 4 being individually controllable by flow control valves 8, so that depending on the position of these flow control valves, the flow in the heating circuit and thus the capacity of the rotary pump 6 may change.

Pump 6 is driven by a three-phase current motor 10, the speed of which may be controlled. In this example, speed control is effected by a frequency converter 12. A power measuring device 14 is arranged in the interconnection line between frequency converter 12 and three-phase current motor 10, which device measures the uptake of electrical power by motor 10 an provides a signal representative of the power uptake, as for instance a direct voltage. A frequency converter with integrated measurement of the uptake of electrical power and an appropriate signal output may optionally be used for this purpose as well. Furthermore it would also be possible to measure the uptake of electrical power ahead of the frequency converter, as the power consumption by the frequency converter has hardly any influence on the feedback control as compared to that by the motor. The power signal output of the power measurement device 14 is connected to the input of a feedback controller 16. The output of feedback controller 16, which in the way described above provides an output value determining the desired speed, for instance a DC voltage between 0 and 10 V or a direct current between 4 and 20 mA, is connected to the control input of the frequency converter 12. The characteristic curve of feedback control by feedback controller 16 may for instance be stored in the feedback controller in tabular form or defined as a mathematical function. Feedback controller 16 in turn preferably is a digital feedback-control device using a microprocessor. Finally it is to be noted that the uptake of electrical power by the electric motor 10 may be measured by any of the means known to skilled artisans without being subject to specific limitations.

1. A process for feedback-controlling the speed of an electric motor (10) driving a rotary machine (6), in particular a pump or fan, according to the capacity requirement at the rotary machine, which is variable with time on the consumer side (4, 8) thereof, using a feedback controller (16) the output of which determines the speed of the electric motor (10), characterized in that the electrical power (P) actually taken up by the electric motor (10) is measured and in that a signal representing the electrical power measured is produced and supplied as input to the feedback controller (16), where it is converted into the desired output according to a predetermined or right then calculated characteristic curve (Pᵢₙₛₜₐₗₗ(Q)).

2. The process according to claim 1, characterized in that a frequency converter (12) is used for controlling the speed of the electric motor (10).

3. The process according to claim 2, characterized in that the electrical power is measured inside the frequency converter (12).

4. The process according to claim 2, characterized in that the electrical power is measured in between the frequency converter (12) and the electric motor (10).

5. A device for carrying out the process according to claim 1, having an electric motor (10) driving a rotary machine (6), control means (12) for the speed of the electric motor, and a feedback controller (16) the feedback-control output of which is connected to the control input of control means (12), characterized in that a power measurement instrument (14) is series connected ahead of the electric motor (10) for measuring the electrical power (P) taken up by the motor, the signal output of which instrument (14) is connected to the input of the feedback controller (16).

6. The device according to claim 5, characterized in that control means (12) is a frequency converter.

7. The device according to claim 6, characterized in that a power measurement instrument (14) is provided inside the frequency converter.

8. The device according to any of claims 5 to 7, characterized in that the feedback controller (16) is realized using a digital feedback-control instrument.

9. The device according to any of claims 5 to 8, characterized in that the rotary machine (6) has characteristic power curves of strictly monotonic course.
